(19) United States
(12) Patent Application Publication
(10) Pub. No.: US 2009/0252192 A1
(43) Pub. Date: Oct. 8, 2009

(54) REDUCED FEEDBACK OPTICAL TRANSMITTER

(75) Inventors: Jack L. Jewell, Boulder, CO (US); Luke A. Graham, Louisville, CO (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 12/099,390

(22) Filed: Apr. 8, 2008

(51) Int. Cl. H01S 3/00

(52) U.S. Cl. 372/101

(57) ABSTRACT

A device including a laser with reduced feedback.

### BACKGROUND

1. Field of the Invention

The present invention relates generally to optical transmitters.

2. Related Art

One of the problems in fiber communications is that optical feedback, typically from the fiber to the laser, affects the laser operation and gives rise to jitter in the timing of the rising and falling edges of the signal. The effects of the feedback are most severe with single-mode lasers, e.g. 1310 nm VCSELs or DFB lasers, but it is also significant with multi-mode lasers, e.g. 850 nm VCSELs or Fabry-Perot (FP) lasers.

### SUMMARY

According to a broad aspect of the present invention, there is provided a device comprising: a laser emitting a lowest-order transverse mode and one or more higher-order transverse modes; a barrel including a receptacle for receiving an optical fiber; and a lens on said barrel, wherein said lens focuses the lowest-order transverse mode at a first focus position on an optical axis and focuses one or more higher-order transverse modes at a second focus position separated along the optical axis from the first focus position.

### BRIEF DESCRIPTION OF THE DRAWINGS

The invention will be described in conjunction with the accompanying drawings, in which:

FIG. 1 is a schematic view of an offset launch of light into a single-mode fiber looking down the fiber core;

FIG. 2 is a schematic side view of the offset launch of FIG. 1 taken in the direction of arrow 2 of FIG. 1;

FIG. 3 is a schematic side view of the offset launch of FIG. 1 taken in the direction of arrow 3 of FIG. 1;

FIG. 4 is a schematic view of an offset launch of light into a single-mode fiber looking down the fiber core;

FIG. 5 is a schematic side view of the offset launch of FIG. 1 taken in the direction of arrow 5 of FIG. 4;

FIG. 6 is a schematic side view of the offset launch of FIG. 1 taken in the direction of arrow 6 of FIG. 4;

FIG. 7 is a schematic cross-sectional view of an optical system including an aligned OSA;

FIG. 8A is a schematic cross-sectional view of the optical system with a VCSEL tilted to form an angled emitted light beam and angled reflected light beam;

FIG. 8B shows the path of the emitted light beam and reflected light beam of the optical system of FIG. 8A, with proportions of the features of the system altered to better show the angular paths of the emitted and reflected light beams;

FIG. 9A is a schematic cross-sectional view of an optical system with a VCSEL and an OSA focusing two different modes at different locations according to one embodiment of the present invention; and

FIG. 9B shows the path of the emitted light beam and reflected light beam for the lowest order transverse mode of the optical system of FIG. 9A, and the emitted light beam from a higher order transverse mode, with proportions of the features of the system altered to better show the angular paths of the emitted and reflected light beams.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “unibody” refers to a device that is constructed of one primary element, as opposed to two or more elements assembled, or removably connected.

For the purposes of the present invention, the term “constructed integrally” refers to a device that has been constructed to include multiple parts having various functions, where the multiple pieces may not be separated from the remainder of the device without damaging the device.

For the purposes of the present invention, the term “axial alignment” refers to two or more items that all lie along the axis of at least one of the items to permit light to pass through each of the items. Two items that are in axial alignment are “coaxial.”

For the purposes of the present invention, the term “laser end” or “proximal end” refers to end of an optical subassembly where a laser is located.

For the purposes of the present invention, the term “fiber end” or “distal end” refers to the end of an optical subassembly where a fiber is inserted into the sub-assembly or where a fiber may be inserted into the sub-assembly.

For the purposes of the present invention, the term “lowest-order transverse mode” refers to the beam emitting from the central portion of the VCSEL aperture, usually originating from a single region in the aperture and usually having a relatively small divergence angle.

For the purposes of the present invention, the term “higher-order transverse mode” refers to any beam emitting from a non-central portion of the VCSEL aperture, usually originating from multiple regions in the aperture and usually having a divergence angle larger than that of the lowest-order transverse mode.

### Description

It has been found experimentally, with parallel optical modules, that misalignment can reduce the effects of feedback with multi-mode 850 nm VCSEL arrays. The effect of misalignment is that the misaligned beam is incident on the fiber at an angle. In fact, intentionally tilting the VCSEL array produces a similar reduction of feedback effects. For an idealized optical system, the reflected light beam should propagate directly back to the VCSEL aperture. Non-ideal systems, e.g. those using a ball lens or other non-ideal lens, may have the beam distorted on the return, which may reduce feedback effects. For a multi-mode VCSEL in a misaligned system or one with the tilted VCSEL, the effects of feedback may be reduced since the reflected light beam incident on the VCSEL will be at a different angle from the emitted light beam.

An objective of the present invention is to produce an optical sub-assembly (OSA) in which the effects of optical feedback are reduced. In a manufacturing environment, it is undesirable to have misalignment or tilting of the laser source. It is therefore a further objective of present invention to provide an optical sub-assembly in which the laser, e.g. VCSEL, does not need to be tilted, and in which misalignment is minimized. It is yet another objective of the present invention to produce and OSA in which the effective modal bandwidth of a multi-mode fiber is improved.

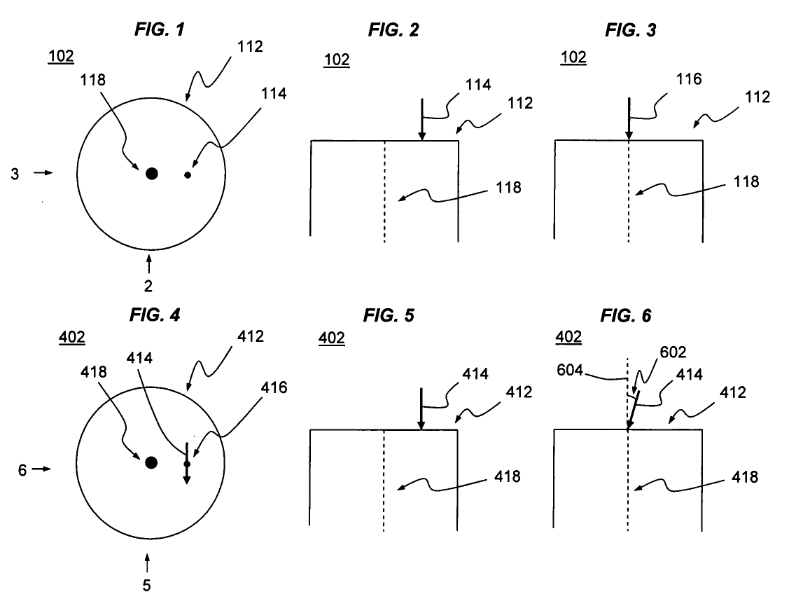

Feedback effects may be decreased and the effective modal bandwidth (MBW) may be increased by an optimized launch condition. In Gigabit Ethernet, even the 500 MHz-km MBW is achieved by an “offset launch” in which light from a single-mode fiber is coupled into a 62.5 μm diameter MMF fiber offset by ˜23 μm from the center. Such an offset launch 102 is shown in FIGS. 1, 2, and 3 showing a fiber core 112 into which is launched a light beam 114 that is offset from optical axis 118 of fiber core 112. FIGS. 1, 2 and 3 show three views of launch 102: looking down fiber core 102 (FIG. 1), looking at the side of fiber core 112 (FIG. 2, the direction of arrow 2 of FIG. 1), and looking at the side of fiber core 112 from an angle 90° rotated from the view of FIG. 2 (FIG. 3, the direction of arrow 3 of FIG. 1). This launches the light away from the innermost and outermost modes, but after propagating some distance in the fiber, the light may redistribute and couple into some of the undesired modes, particularly the innermost modes.

The effective MBW may be further improved by introducing an azimuthal angle to the launch into the fiber, for example an angle between 1 and 10 degrees. Such an angled offset launch 402 is shown in FIGS. 4, 5, and 6 showing a fiber core 412 into which is launched a light beam 414 that enters fiber core 412 at a point 416 offset from optical axis 418 of fiber core 412. As shown in FIG. 6, light beam 414 is launched into fiber core 412 at an angle 602 to a vertical line 604 extending from optical axis 418. Together vertical line 604 and optical axis 418 of FIGS. 4, 5 and 6 show three views of launch 402: looking down fiber core 412 (FIG. 4), looking at the side of fiber core 412 (FIG. 5, the direction of arrow 5 of FIG. 1), and looking at the side of fiber core 414 from an angle 90° rotated from the view of FIG. 5 (FIG. 6, the direction of arrow 6 of FIG. 1).

The azimuthal angular component to the launch shown in FIGS. 4, 5 and 6 minimizes the coupling into the innermost modes, since the light tends to propagate in a spiral pattern down the fiber. The “offset azimuthal launch” may be accomplished by 1) introducing the azimuthal angle into the optical subassembly; 2) aligning to a single-mode fiber; 3) laterally translating the laser by a distance which produces the desired lateral offset; and/or 4) setting the components in place. The angular incidence of the beam onto the fiber will reduce the effects of the reflected light beam on the VCSEL, especially if the VCSEL is a multi-mode VCSEL. Tilting the VCSEL will cause the beam incident on the fiber to be at an angle. If the displacement is in a direction orthogonal to the plane defined by the beam and the optical axis of the fiber, then the angle will be in an azimuthal orientation.

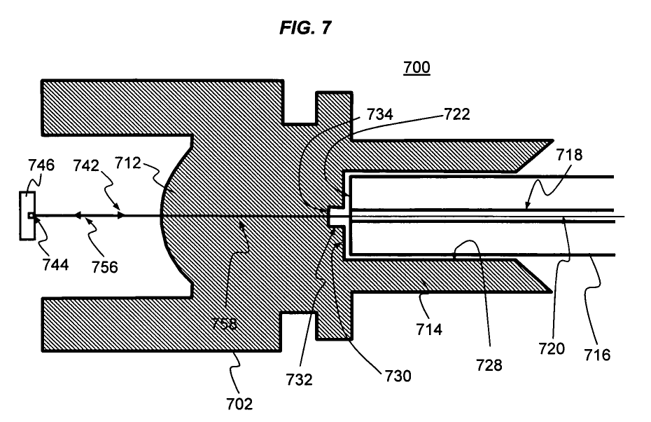

FIG. 7 shows an example of an optical system 700 including an aligned unibody OSA 702 including a lens 712 and a fiber receptacle 714 for receiving an optical fiber 716 having a fiber core 718, a fiber axis 720, and a flat fiber distal end 722. Fiber receptacle 714 has a cylindrical interior surface 728 having an interior surface distal end 730 that includes a cylindrical recess 732 having a straight lens rear surface 734, which may be optically flat, concave, convex, faceted, or any other shape. An emitted light beam, indicated by right-pointing arrowhead 742, is emitted from an aperture 744 of a flat mounted VCSEL 746, travels through lens 712 and becomes incident on fiber distal end 722 at fiber axis 720. A portion of the emitted light beam is reflected by fiber distal end 722 as a reflected light beam, indicated by left-pointing arrowhead 756, and is returned straight back, along optical axis 758, into an aperture 744 of VCSEL 746. Optical fiber 714 includes a flat distal end 722 that reflects the emitted light beam. Lens rear surface 734 is considered “straight” because lens rear surface 734 is perpendicular to fiber axis 720 and optical axis 758 that extends along fiber axis 720.

In FIG. 7, the reflected light beam may enter the VCSEL aperture and interfere with the light being generated by the VCSEL, with constructive and destructive interference varying rapidly, thereby causing intensity fluctuations in the emitted light beam, which gives rise to noise and jitter in the signal.

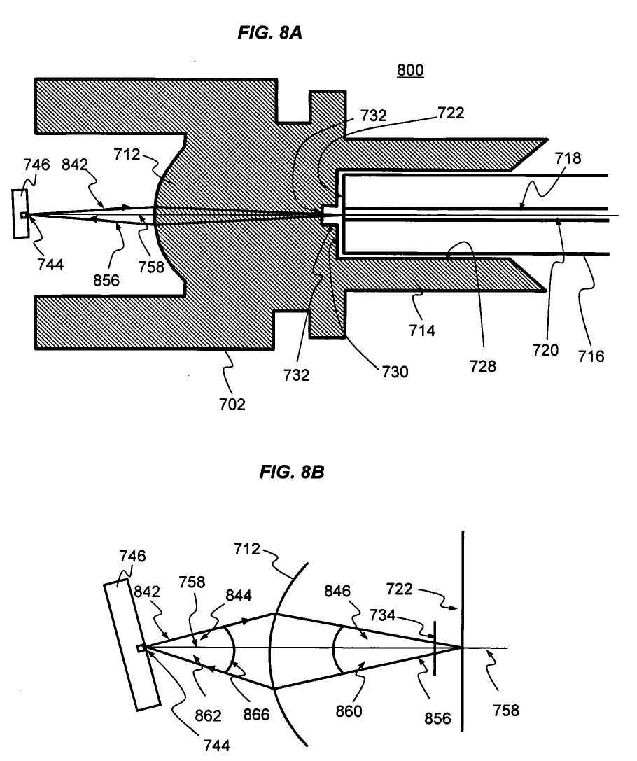

FIGS. 8A and 8B show the effect of tilting the VCSEL 746 of FIG. 7. In optical system 800, an emitted light beam 842 propagates at an angle 844 with respect to optical axis 758. Emitted light beam 842 is refracted by lens 712 to make an angle 846 with optical axis 758 and becomes incident on fiber distal end 722 at fiber axis 720. A portion of emitted light beam 842 is reflected by fiber distal end 722 to form reflected light beam 856. Reflected light beam 856 is reflected at an angle 860 with respect to optical axis 758. Reflected light beam 856 is refracted by lens 712 so that reflected light beam 856 enters the aperture (not shown) of VCSEL 746 at an angle 862 with respect to optical axis 758. Reflected light beam 856 is incident on VCSEL aperture 744 at a relative angle 866 (the sum of angles 844 and 862) that is two times angle 844, the tilt angle of VCSEL 746.

In a system such as shown in FIGS. 8A and 8B, the reflected light beam may be degraded relative to the emitted light beam due to the double pass through the lens system. The angle between the emitted and reflected beams produces variation in the constructive and destructive interferences, thereby decreasing the overall intensity fluctuations. A lens system having some aberrations is also likely to result in less feedback than a perfect lens. Also, as mentioned earlier, tilting of components is undesirable in a manufacturing environment.

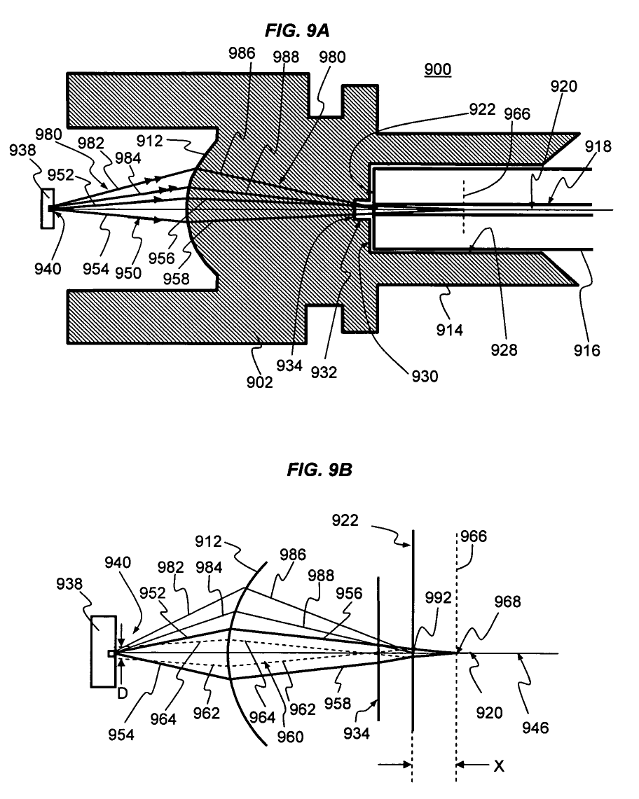

FIGS. 9A and 9B show an optical system 900 according to one embodiment of the present invention. Optical system 900 includes a unibody OSA barrel 902 having a lens 912 and a fiber receptacle 914 for receiving an optical fiber 916 having a fiber core 918, a fiber axis 920, and a flat fiber distal end 922. Fiber receptacle 914 has a cylindrical interior surface 928 having an interior surface distal end 930 that includes a cylindrical recess 932 having lens rear surface 934. VCSEL 938 is mounted flat and has an aperture 940 that is approximately centered with respect to fiber axis 920 and optical axis 946. An emitted light beam 950 from a fundamental or lowest-order transverse mode is represented by rays 952 and 954 from aperture 940 of VCSEL 938 which diverge until emitted light beam 950 is refracted by lens 912 to converge as represented by rays 956 and 958. Then, emitted light beam 952 is refracted by lens rear surface 934 along a slightly more convergent path until emitted light beam 952 is incident on flat fiber distal end 922. As shown, emitted light beam is not focused on flat fiber distal end 922, but is focused inside fiber core 918 in plane 966 at focus position 968. A portion of emitted light beam 952 is then reflected from fiber distal end 922 as reflected light beam 960, represented by light rays 962 and 964. Reflected light beam 960 is refracted by lens rear surface 934 and by lens front surface 912. Reflected light beam 960 is then incident on the aperture 940 of VCSEL 938. Due to the defocusing of emitted light beam 950 on flat fiber distal end 922, reflected light beam 960 is even more defocused on aperture 940 and is shown in FIG. 9B to have a diameter D which is much larger than the diameter of aperture 940. Thus, most of reflected light beam 960 does not enter aperture 940, and the effects of optical feedback for the lowest-order transverse mode are reduced.

An emitted light beam 980 from a higher-order transverse mode is represented by rays 982 and 984 from aperture 940 of VCSEL 938 which diverge until emitted light beam 980 is refracted by lens 912 to converge as represented by rays 986 and 988. Then, emitted light beam 980 is refracted by lens rear surface 934 along a slightly more convergent path until emitted light beam 980 is incident on flat fiber distal end 922 at fiber axis 920. As shown, emitted light beam 980 from the higher-order transverse mode is focused at focus position 992 which is approximately focused on flat fiber distal end 922. A portion of emitted light beam 980 is then reflected from fiber distal end 922. Although not shown, the reflection of emitted light beam 980 of a higher-order transverse mode is refracted by lens rear surface 934 and by lens front surface 912. Reflected light from emitted light beam 980 is then incident on the aperture 940 of VCSEL 938. VCSEL 938 is not as sensitive to reflections from a higher-order transverse mode as it is from the lowest-order transverse mode. The distance X, shown in FIG. 9B is defined as the distance between focus position 968 of the lowest-order transverse mode and a focus position 992 of a higher-order transverse mode.

In the optical system shown in FIGS. 9A and 9B, aberrations from the light beam pathways shown may be due to aberrations in the lens design and/or alignment between the components of the system. A spherically shaped lens 912 qualitatively produces the focusing characteristics shown in FIGS. 9A and 9B, which may reduce the feedback effects though perhaps not optimally. While spherically-shaped ball lenses were used in the past for VCSEL OSAs and are often used for single-mode OSAs, molded-plastic TOSAs such as the OSA shown in FIG. 9A employ aspherical surfaces which focus all rays from the emitted beam in approximately the same plane. Without the present inventive concept, it would be counter-intuitive for one skilled in the art to design an OSA deliberately with aberrations or even a spherical surface when it is straightforward to manufacture an “improved” aspherical surface. In U.S. Pat. No. 5,319,496 to Jewell et al., the entire contents and disclosure of which is hereby incorporated by reference, describes the use of aberrations to focus multiple VCSEL modes onto a smaller spot area. The present invention is opposite in nature in that the multiple modes are deliberately focused at different locations. The application and characteristics of the present invention differ greatly from that of U.S. Pat. No. 5,319,496. Some advantageous characteristics of an OSA of the present invention, such as the OSA of FIG. 9A, are: 1) the coupling efficiency into the fiber of the lowest-order transverse mode is most tolerant to misalignment, e.g. defocus or displacement and 2) the VCSEL is most sensitive to feedback from the lowest-order transverse mode. An OSA of the present invention may reduce the effects of feedback without sacrificing coupling efficiency.

Although in the embodiment shown in FIGS. 9A and 9B in which the focus position of the lowest-order transverse mode is inside the fiber, in another embodiment the focus position of the lowest-order transverse mode may be outside the fiber and/or the focus position of a higher-order transverse mode may be inside or outside the fiber.

In one embodiment, the present invention provides an OSA in which the distance between the focus point for the lowest-order transverse mode and for a higher-order transverse mode is 20 micrometers or more. In another embodiment, the present invention provides an OSA in which the distance between the focus point for the lowest-order transverse mode and for a higher-order transverse mode is 50 micrometers, or more. One property of a lens that may cause the distance between the lowest-order transverse mode focus point and a higher-order transverse mode focus point to be significant is spherical aberration. Normally lenses are designed to have minimal spherical aberration, for example less than one quarter wave. In one embodiment the present invention employs an OSA with a lens having more than one half wave of spherical aberration.

Although the lens rear surface in the embodiment of the present invention shown in FIGS. 9A and 9B is optically flat, the lens rear surface may be concave, convex, faceted, or any other shape, such as the lens rear surface shapes described and shown in U.S. patent application Ser. No. 12/042,062 to Jewell et al., entitled “Low-Noise Optical Transmitter,” filed Mar. 4, 2008, the entire contents and disclosure of which is hereby incorporated by reference.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A device comprising:
a laser emitting a lowest-order transverse mode and one or more higher-order transverse modes;
a barrel including a receptacle for receiving an optical fiber; and
a lens on said barrel, wherein said lens focuses the lowest-order transverse mode at a first focus position on an optical axis and focuses one or more higher-order transverse modes at a second focus position separated along the optical axis from the first focus position.

2. The device of claim 1, wherein the second focus position is separated from the first focus position by at least 20 micrometers.

3. The device of claim 1, wherein the second focus position is separated from the first focus position by at least 50 micrometers.

4. The device of claim 1, further comprising a fiber that has a flat fiber distal end, wherein the first focus position is inside the fiber and the second focus position is approximately at the flat fiber distal end.

5. The device of claim 1, further comprising a fiber that has a flat fiber distal end, wherein the second focus position is approximately at the flat fiber distal end and the first fiber position is outside the fiber.

6. The device of claim 1, wherein the lens has at least one half wave of spherical aberration.
